(19) United States
(12) Patent Application Publication
(10) Pub. No.: US 2025/0361410 A1
(43) Pub. Date: Nov. 27, 2025

(54) MICROBIAL-RESISTANT DISPERSANT

(71) Applicant: Rohm and Haas Company, Collegeville, PA (US)

(72) Inventors: Erica A. Frankel, Audubon, PA (US); Tara L. Conley, Chalfont, PA (US)

(21) Appl. No.: 18/873,875

(22) PCT Filed: Jun. 21, 2023
(86) PCT No.: PCT/US2023/068765

§ 371 Date: Dec. 11, 2024

Related U.S. Application Data
(60) Provisional application No. 63/355,782, filed on Jun. 27, 2022.

(51) Int. Cl. C09D 7/45; C08K 5/17; C09D 7/63; C09D 7/65

(52) U.S. Cl. CPC C09D 7/45; C09D 7/63; C09D 7/65; C08K 5/17

(57) ABSTRACT

The present invention relates to a composition comprising water, a carboxylic acid functionalized dispersant and a compound of Formula (I): where R, R¹, x, and y are as defined herein. The composition of the present invention is useful as a biocide-free additive for pre-paint formulations.

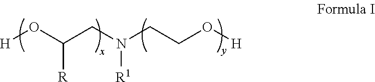

### BACKGROUND OF THE INVENTION

The present invention relates to a microbial-resistant dispersant, more particularly, a dispersant that has preservative properties in the absence of a biocide.

Isothiazolinones are commonly used as preservatives in a wide variety of consumer products including architectural coatings. However, isothiazolinones are known skin sensitizers and have come under increased scrutiny by regulators for use in a variety of consumer products. In 2016, the European Commission issued a directive to limit the use of methylisothiazolinone (MIT) in most consumer products, including house paint. By 2021, the EU decided that it would not permit final formulations of these products to contain more than 15 ppm of MIT. These stringent restrictions present a challenge for paint formulators looking to control the amount of biocide in their final product. It would therefore be an advance in the art of architectural coatings to discover a biocide-free solution for preserving additives used in paint formulations.

### SUMMARY OF THE INVENTION

The present invention addresses a need in the art by providing composition comprising, based on the weight of the composition, a) from 50 to 90 weight percent water, b) from 9 to 45 weight percent of a carboxylic acid functionalized dispersant; c) and from 0.5 to 10 weight percent of a compound of Formula I:

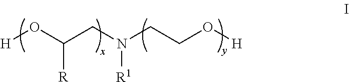

wherein each R is independently H, methyl, or ethyl;

R¹=—R²—NR³—(CH₂CH₂O)_{z}—H; or —C₆—C₁₈-alkyl; or —C(CH₃)₂R⁴;

x is from 1 to 40; y is from 0 to 39; and z is from 0 to 39;

with the proviso that when y is 0, R¹ is —C(CH₃)₂R⁴; and when y is from 1 to 39, R¹ is —R²—NR³—(CH₂CH₂O)_{y}—H or —C₆—C₁₈-alkyl;

R² is —CH₂CH₂CH₂— or —CH(CH₃)CH₂— or —CH₂CH(CH₃)—;

R³ is saturated or partially unsaturated C₁₀—C₂₂-alkyl;

R⁴ is C₁—C₂₀-alkyl; and

$$x + y + z = 1 to 40 ;$$

wherein at least 80 weight percent of the composition comprises water, the dispersant, and the compound for Formula I; and wherein the composition has a pH in the range of from 8 to 11.

The composition of the present invention is useful as a biocide-free additive for paint or pre-paint formulations.

### DETAILED DESCRIPTION OF THE INVENTION

The present invention is a composition comprising, based on the weight of the composition, a) from 50 to 90 weight percent water, b) from 9 to 45 weight percent of a carboxylic acid functionalized dispersant; c) and from 0.5 to 10 weight percent of a compound of Formula I:

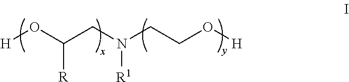

wherein each R is independently H, methyl, or ethyl;

R¹=—R²—NR³—(CH₂CH₂))_{z}—H; or —C₆—C₁₈-alkyl; or —C(CH₃)₂R⁴;

x is from 1 to 40; y is from 0 to 39; and z is from 0 to 39;

with the proviso that when y is 0, R¹ is —C(CH₃)₂R⁴; and when y is from 1 to 39, R¹ is —R²—NR³—(CH₂CH₂O)_{y}—H or —C₆—C₁₈-alkyl;

R² is —CH₂CH₂CH₂— or —CH(CH₃)CH₂— or —CH₂CH(CH₃)—;

R³ is saturated or partially unsaturated C₁₀—C₂₂-alkyl;

R⁴ is C₁—C₂₀-alkyl; and

$$x + y + z = 1 to 40 ;$$

wherein at least 80 weight percent of the composition comprises water, the dispersant, and the compound for Formula I; and wherein the composition has a pH in the range of from 8 to 11.

The term carboxylic acid functionalized dispersant refers to a polymer functionalized with COO⁻X⁺ groups, where X is a counterion such as sodium, potassium, or ammonium. Examples of suitable dispersants include acrylic acid (AA) homopolymers, methacrylic acid (MAA) homopolymers, copolymers of AA and MAA, copolymers of AA or MAA and an acrylate or methacrylate monomer such as hydroxypropyl acrylate (HPA) or hydroxyethyl methacrylate (HEMA), copolymers of maleic anhydride (MA) and diisobutylene (DIB). A dispersant prepared from maleic anhydride becomes carboxylic acid functionalized because the maleic anhydride groups hydrolyze to carboxylate groups in the presence of a base.

The concentration of the carboxylic acid functionalized dispersant, based on the weight of the composition, is in the range of from 9 or from 15 or from 18 weight percent, to 45 or to 42 weight percent. The concentration of water is in the range of from 50 or from 55 weight percent, to 90 or to 85 weight percent.

The concentration of the compound of Formula I, based on the weight of the composition, is in the range of from 0.5 or from 1 or from 1.5 or from 2 weight percent to 10 or to 8 or to 6 weight percent. Where y is 0, the compound of Formula I is represented by Formula Ia:

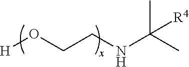

where R⁴ is preferably C₆—C₁₄-alkyl, and x=2 to 30, or 10, or to 5. Examples of commercial surfactants within the scope of Formula Ia include TRITON™ RW-20 (RW-20, x=2, R⁴=decyl), TRITON™ RW-50 (RW-50, x=5, R⁴=decyl), and TRITON™ RW-150 (RW-150, x=15, R⁴=decyl) Surfactants. (TRITON is a Trademark of The Dow Chemical Company or its Affiliates.)

Another subgenus of the compound of Formula I is represented by Formula Ib:

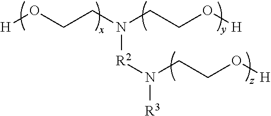

where R³ is preferably saturated or partially saturated C₁₄—C₂₀-alkyl, or saturated or partially saturated C₁₆—C₁₈-alkyl, and x+y+z=2 to 32. As used herein, “partially unsaturated” refers to the presence of one or two double bond within the alkyl chain. Examples of commercial surfactants within the scope of Formula Ib include Ethox DT-15 (DT-15, x+y+z=15); and Ethox DT-30 (DT-30, x+y+z=30) Tallow diamines.

Yet another subgenus of the surfactant of Formula I is illustrated by Formula Ic:

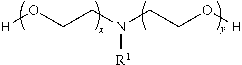

where R¹ is preferably C₁₂—C₁₈-alkyl, and x+y=12 to 18. An example of a commercial surfactant within the scope of Formula Ic is Ethox CAM-15 Cocoamine (CAM-15, x+y=15).

The weight-to-weight ratio of the dispersant to a compound of Formula I is typically in the range of from 5:1 to 10:1. The pH of the composition is in the range of from 8, or from 8.5, to 11 or to 10 or to 9.5. The desired pH is conveniently achieved by addition of a neutralizer, which is preferably an amine such as 2-amino-2-methyl-1-propanol.

The composition may further comprise an ancillary surfactant such as a nonionic ethoxylated and/or propoxylated C₆—C₁₂ alcohol or C₈—C₁₂ alcohol. The concentration of the ancillary surfactant, if used, is generally in the range of from 1 to 20 weight percent, based on the weight of the composition. A commercially available ancillary surfactant is TRITON™ DF-16 nonionic surfactant (DF-16).

The composition of the present invention may be admixed with a pre-paint additive such as TiO₂ to impart preservative properties to the pre-paint.

### EXAMPLES

### Preparation of Compositions

Solutions of dispersant were placed in 50-mL conical tubes and vortexed with surfactant and sufficient AMP-95 2-amino-2-methyl-1-propanol neutralizer to achieve a final pH of ˜9.5. Table 1 illustrates the relative proportions of the Dispersant; Surfactant I (RW-20, which is a compound within the scope of Formula I); Surfactant II (DF-16 which is used in example 4 only). 1124 refers to TAMOL™ 1124 Dispersant (a copolymer of AA and HPA); 165A refers to TAMOL™ 165A Dispersant (a copolymer of MA and DIB); and 851 refers to TAMOL™ 851 Dispersant (AA homopolymer). Table 1 illustrates the make-up of the dispersant compositions. The weight % s of water in each sample is the difference between 100 and the sum of the dispersant and the surfactant.

TABLE 1
Dispersant Compositions

| Ex. | | | | Dispersant | Surfactant I | Surfactant II |
|---|---|---|---|---|---|---|
| No. | Dispersant | Surfactant I | Surfactant II | (wt %) | (wt %) | (wt %) |
| 1 | 1124 | RW-20 | — | 40 | 5 | — |
| 2 | 165A | RW-20 | — | 20 | 2.5 | — |
| 3 | 851 | RW-20 | — | 25 | 3.1 | — |
| 4 | 1124 | RW-20 | DF-16 | 35 | 5 | 20 |

### Preparation of Samples for Microbial Resistance of TiO₂

Four samples were prepared by adding each of the dispersant compositions of Examples 1-4 with Kronos 2311 TiO₂ slurry to a speedmixer (Flaktek, Inc.) with mixing at 1500 rpm for 2 min. A comparative Dispersant Blend was prepared by combining a sample that did not contain RW-20 with the TiO₂ slurry. Table 2 illustrates the make-up of the modified TiO₂ slurry compositions. Kronos 2311 TiO₂ Slurry was used as the opacifying pigment for each study. Composition refers to the dispersant compositions of Examples 1-4.

TABLE 2
TiO₂ Slurry Compositions

| Sample | Ex. No. | TiO₂ (g) | Composition (g) | Water (g) |
|---|---|---|---|---|
| 1 | Ex. 1 | 76.5 | 0.50 | 23.0 |
| 2 | Ex. 2 | 76.5 | 1.00 | 22.5 |
| 3 | Ex. 3 | 76.5 | 0.80 | 22.7 |
| 4 | Ex. 4 | 76.5 | 0.57 | 22.9 |

The concentration of dispersant in each sample was 0.2 weight percent, based on the weight of the sample.

The dispersant compositions and the slurry compositions were inoculated 3 times at 7-d intervals with 10⁶-10⁷ colony forming units per milliliter of sample (CFU/mL) of a standard pool of bacteria, yeasts, and molds obtained from American Type Culture Collection (ATCC) that are common contaminants in coatings. Once inoculated, the samples were stored in 25° C. incubators. Test samples were monitored for microbial contamination by agar plating using a standard streak plate method. Samples were plated 1 d and 7 d after each microbial challenge onto trypticase soy agar (TSA) and potato dextrose agar (PDA) plates. All agar plates were checked daily up to 7 d after plating to determine the number of microorganisms surviving in the test samples. When not being checked, the agar plates were stored in incubators, 30° C. for TSA plates and 25° C. for PDA plates. The extent of microbial contamination was established by counting the colonies, where the rating score was determined from the number of microbial colonies observed on the agar plates. Reported results come from day 7 readings. Results are described by the rating score for each type of microorganism: B=bacteria, Y=yeast, and M=mold. For example, a 3B describes a plate with 3 rating score for bacteria, or a Tr Y(1) describes a plate with trace yeast (1 colony on plate). Table 1 illustrates the rating system used to estimate the level of microbial contamination on streak plates. Colonies refers to the number of colonies on the plate. Table 3 illustrates the rating system estimating microbial contamination.

TABLE 3
Rating system for estimating microbial contamination

| Colonies | Rating Score | Contamination | Result |
|---|---|---|---|
| None | 0 | None | Pass |
| 1-9 | Tr | Trace | Pass |
| 10 to 99 | 1 | Very Light | Fail |
| 100 to ~1000 | 2 | Light | Fail |
| ~1000 to 10,000 | 3 | Moderate | Fail |
| >10,000 | 4 | Heavy | Fail |

Table 4 illustrates the results of three challenge tests (C1-C3) for the dispersant compositions.

TABLE 4
Challenge Test Results for Dispersant Compositions

| Ex. No. | C1 Final | C2 Final | C3 Final |
|---|---|---|---|
| 1 | PASS | PASS | PASS |
| 2 | PASS | PASS | PASS |
| 3 | PASS | PASS | PASS |
| 4 | PASS | PASS | PASS |

In contrast, the copolymer of AA and HPA and the homopolymer of AA that did not contain the RW-20 amine ethoxylate surfactant failed all three challenge tests.

Table 5 illustrates the three challenge tests for the TiO₂ slurry compositions. Comparative Sample 1 (Comp. 1) was prepared without RW-20.

TABLE 5
Challenge Test Results for TiO₂ Slurry Compositions

| Sample | TiO₂ | Dispersant Blend | C1 Final | C2 Final | C3 Final |
|---|---|---|---|---|---|
| Comp. 1 | Kronos 2311 | no RW-20 | FAIL | FAIL | FAIL |
| 1 | Kronos 2311 | 1 | PASS | PASS | PASS |
| 2 | Kronos 2311 | 2 | PASS | PASS | PASS |
| 3 | Kronos 2311 | 3 | PASS | PASS | PASS |
| 4 | Kronos 2311 | 4 | PASS | PASS | PASS |

The results show the efficacy of the dispersant composition beyond preservation of the composition itself. It is believed that the dispersant composition would be useful in improvement the preservation of other additives used in paint formulations.

1. A composition comprising, based on the weight of the composition, a) from 50 to 90 weight percent water, b) from 9 to 45 weight percent of a carboxylic acid functionalized dispersant; c) and from 0.5 to 10 weight percent of a compound of Formula I: 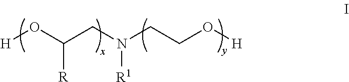
wherein each R is independently H, methyl, or ethyl;
R¹=—R²—NR³—(CH₂CH₂O)_{z}—H; or —C₆—C₁₈-alkyl; or —C(CH₃)₂R⁴;
x is from 1 to 40; y is from 0 to 39; and z is from 0 to 39;
with the proviso that when y is 0, R¹ is —C(CH₃)₂R⁴; and when y is from 1 to 39, R¹ is —R²—NR³—(CH₂CH₂O)_{y}—H or —F-alkyl;
R² is —CH₂CH₂CH₂— or —CH(CH₃)CH₂— or —CH₂CH(CH₃)—;
R³ is saturated or partially unsaturated C₁₀—C₂₂-alkyl;
R⁴ is C₁—C₂₀-alkyl; and
$$x + y + z = 1 to 40 ;$$
wherein at least 80 weight percent of the composition comprises water, the dispersant, and the compound for Formula I; and wherein the composition has a pH in the range of from 8 to 11.

2. The composition of claim 1 which has a pH in the range of from 8.5 to 10 wherein, based on the weight of the composition, the concentration of water is in the range of from 55 to 85 weight percent; the concentration of the carboxylic acid functionalized dispersant is in the range of from 15 to 45 weight percent; and the concentration of the compound of Formula I is in the range of from 1.5 to 8 weight percent.

3. The composition of claim 2 wherein the compound of Formula I is represented by the compound of Formula Ia: 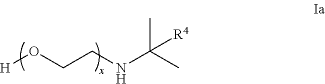
where R⁴ is C₆—C₁₄-alkyl, and x=2 to 30;
or the compound of Formula Ib: 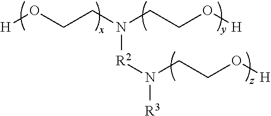
where R³ is a saturated or partially saturated C₁₄—C₂₀-alkyl, or saturated or partially saturated C₁₆—C₁₈-alkyl, and x+y+z=2 to 32;
or the compound of Formula Ic: 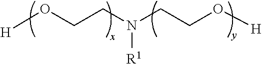
where R¹ is C₁₂—C₁₈-alkyl, and x+y=12 to 18.

4. The composition of claim 3 wherein the compound of Formula I is represented by the compound of Formula Ia: 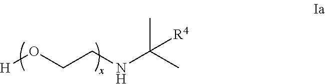
where R⁴ is decyl and x=2 to 10.

5. The composition of claim 3 wherein the weight-to-weight ratio of the carboxylic acid functionalized dispersant to the compound of Formula Ia is in the range of from 5:1 to 10:1; wherein the composition further includes 2-amino-2-methyl-1-propanol.

6. The composition of claim 1 wherein the carboxylic acid functionalized dispersant is selected from the group consisting of a homopolymer of acrylic acid, a homopolymer of methacrylic acid, a copolymer of acrylic acid and methacrylic acid, a copolymer of acrylic acid and hydroxypropyl acrylate, a copolymer of acrylic acid and hydroxyethyl methacrylate, a copolymer of methacrylic acid and hydroxypropyl acrylate, a copolymer of methacrylic acid and hydroxyethyl methacrylate, and a copolymer of maleic anhydride and diisobutylene; wherein the composition further includes 2-amino-2-methyl-1-propanol.

7. The composition of claim 6 wherein the carboxylic acid functionalized dispersant is selected from the group consisting of a homopolymer of acrylic acid, a copolymer of methacrylic acid and hydroxypropyl acrylate, and a copolymer of maleic anhydride and diisobutylene.

8. The composition of claim 1 which further comprises, based on the weight of the composition, from 1 to 20 weight percent of a nonionic ethoxylated C₆—C₁₂ alcohol, or a nonionic propoxylated C₆—C₁₂ alcohol or a nonionic ethoxylated-propoxylated C₆—C₁₂ alcohol.

9. The composition of claim 4 wherein the weight-to-weight ratio of the carboxylic acid functionalized dispersant to the compound of Formula Ia is in the range of from 5:1 to 10:1; wherein the composition further includes 2-amino-2-methyl-1-propanol.
